(19) United States
(12) Patent Application Publication
(10) Pub. No.: US 2021/0380020 A1
(43) Pub. Date: Dec. 9, 2021

(54) SYSTEM FOR ENERGY MANAGEMENT OF BATTERY-SUPPLIED INDUSTRIAL TRUCKS

(71) Applicant: Jungheinrich Aktiengesellschaft, Hamburg (DE)

(72) Inventor: Arne Mahler, Henstedt-Ulzburg (DE)

(73) Assignee: Jungheinrich Aktiengesellschaft, Hamburg (DE)

(21) Appl. No.: 17/339,212

(22) Filed: Jun. 4, 2021

(30) Foreign Application Priority Data
Jun. 4, 2020 (DE) 10 2020 114 866.6

(51) Int. Cl. B60L 58/12; G05B 13/02; G06Q 30/02; G05D 1/00; B60L 53/62

(52) U.S. Cl. CPC B60L 58/12; G05B 13/024; B60L 53/62; G05D 1/0088; G06Q 30/0284

(57) ABSTRACT

A system for energy management of a plurality of battery-powered industrial trucks comprises an energy control unit. The energy control unit is configured to receive data on a current charging state of the plurality of battery-powered industrial trucks, receive data on a probable demand for the plurality of battery-powered industrial trucks, and receive data on use of chargers used to charge the plurality of battery-powered industrial trucks. The energy control unit is further configured to use the received data to determine when each of the plurality of battery-powered industrial truck is being charged at an available charger, and when each of the plurality of battery-powered industrial truck is being used for the probable demand.

### CROSS REFERENCE TO RELATED INVENTION

This application is based upon and claims priority to, under relevant sections of 35 U.S.C. § 119, German Patent Application No. 10 2020 114 866.6, filed Jun. 4, 2020, the entire contents of which are hereby incorporated by reference.

### FIELD OF TECHNOLOGY

The present invention relates to a system for energy management of battery-supplied industrial trucks that have an energy control unit. More specifically, the present invention relates to an optimization of energy use, and a cost reduction associated therewith in the use of battery-supplied industrial trucks. In particular with the increasing use of renewable energies, the current price of electrical power can fluctuate significantly, sometimes also over the course of the day. In addition, electrical supply networks are increasingly dependent on intelligent consumers and customers in order to ensure favorable network stability and quality.

### BACKGROUND

An energy supply system was disclosed in DE 10 2012 212 878 A1 with a solar energy production apparatus and an energy storage apparatus, wherein the charging and discharging of the energy storage apparatus are controlled in agreement with a predetermined charging/discharging plan.

A method was disclosed in WO 2011/092821 A1 in which the amount of energy taken from a power network is determined depending on the power costs, the required amount of energy, the locally generated energy and the charging state of an energy storage system.

A method for charging an electrically driven vehicle was disclosed in U.S. Pat. No. 10,011,183 B2 in which the vehicle is charged by a local energy source depending on the expected operation of the electrically driven industrial truck.

A method for coordinating charging processes of batteries of several industrial trucks was disclosed in DE 10 2017 128 590 A1, wherein a central control unit wirelessly receives operating data on the batteries and monitors use states of several chargers. Depending on the operating data of the batteries and the use of the chargers, the central control unit wirelessly sends a charging permission to industrial trucks not connected to the chargers. This wirelessly exchanged operating data also includes the current charging states of the batteries of the industrial trucks.

In the use of battery-supplied industrial trucks, it is known to connect to them via a control system to a warehouse management system (WMS). It is also known that automated guided industrial trucks (AGV) automatically drive to a charging station to be recharged at the end of their electrical storage.

### BRIEF SUMMARY OF THE INVENTION

The object of the invention is to provide an energy management system for battery-supplied industrial trucks that integrates existing systems and simultaneously optimizes the charging and the use of the industrial trucks.

An embodiment of a system for coordinating the withdrawal of energy from the electrical supply network for a plurality of battery-supplied industrial trucks comprises an energy control unit to which are applied data on the current charging state of the batteries of several industrial trucks, data on a probable demand for industrial trucks, and data on the use of chargers. These data therefore relate to the electrical energy currently stored in the industrial trucks, the anticipated energy demand of the industrial trucks, and the availability of the chargers. From these applied data, the energy control unit is configured to determine for an industrial truck the time at which it should be charged, and the time when it can be used for the probable demand for industrial trucks can also be determined. The energy management according to the invention therefore goes significantly beyond pure charging management, which determines a charging time depending on the charging state of the battery. The system according to the invention also takes into account the extent of the probable demand for industrial trucks, and accordingly when the industrial truck will probably be used. The two times for charging and using the industrial truck are coordinated against the background of the availability of the chargers for the industrial truck. The energy management system accordingly creates an efficient means by which a fleet of industrial trucks can be efficiently used and coordinated.

In an embodiment, the battery-supplied industrial trucks for the energy management system comprise at least one automated guided vehicle (AGV) or automated guided industrial truck. Automated guided industrial trucks receive a driving order and automatically implement it. The energy system according to the invention can be used very advantageously, particularly with automated guided industrial trucks. The amount of orders to be processed and their time schedule, for example, are known from a warehouse management system (WMS). The coordinating energy control unit can hence very reliably access the probable demand for industrial trucks. Advantages of the energy systems also result with manually guided industrial trucks when the users adhere to transmitted specifications for charging instructions and correspondingly implement them. These specifications can be visually and/or acoustically presented to the users on the industrial truck.

In an embodiment, the system comprises a control system for the industrial trucks that is configured to generate driving orders for individual industrial trucks and send these orders to them. A driving order includes for example an approach path to goods to be picked up, the pick-up of the goods, and a transport path along which the picked-up goods are to be transported to their target location. Preferably, the control system is designed to receive a charging command for an industrial truck from the control unit and to forward it to the corresponding industrial truck. This forwarding can be done taking into account a driving order to be implemented automatically. In an embodiment, the charging system is also configured to receive a charging command from the control unit for an industrial truck and is configured to forward this charging command to the corresponding industrial truck. The received charging command causes the industrial truck, especially as an independently driving and steering industrial truck, to drive to an assigned charging station, and a charging process is correspondingly initiated.

In an embodiment, the energy control unit is configured to receive parameters for a current state of a power network and to control a charging and/or a discharging process for at least one of the batteries in order to support the power network. An important key aspect of this embodiment is that the energy control unit monitors the current state of the power network and controls the charging and/or discharging process of the industrial trucks in a manner correspondingly coordinated therewith. The current status of the power network, which can for example make it necessary to intervene by controlling the batteries, can for example relate to over- and under-frequencies, or also over- and undervoltages of the electrical supply network. Furthermore, changes in the power factor can also perform network-supporting functions to a limited extent. In particular, the fact that this network-supporting function occurs while employing the probable demand for industrial trucks makes it clear that the network-supporting function does not necessarily lead to a restricted use of the industrial trucks. The short-term injection of electrical power from the batteries connected to the charger does in fact reduce their charge level, but does not mean that the probable demand for industrial trucks cannot be met.

In an embodiment, the control unit is configured to choose between at least two different electrical supply networks to supply the chargers, and to choose between the different supply networks according to a current purchase price for electrical power. This configuration of the control unit serves to reduce costs. The at least two electrical supply networks can for example be the public electrical supply network and a private supply network, for example fed by a photovoltaic system. The control unit then has the option of comparing the costs of these two supply networks with each other with respect to the current purchase prices and correspondingly switching. Analogously, the control unit may be configured to inject electrical power from the connected batteries into the electrical supply network. This is preferably done as already mentioned from the vantage points of network stabilization. It is however also possible to do this from the vantage points of cost if for example the paid price for injected electrical power is particularly high. In this case as well, the possibility of using the industrial trucks should of course not be restricted, and any additional energy that is probably not required for the industrial trucks is injected.

In an embodiment, the control system is configured to receive data from a warehouse management system and evaluate it when determining the probable demand for industrial trucks. In this way, the control system can access current data and does not have to access empirical or estimated data. The probable demand can in this case refer to a probable energy demand by the industrial trucks, or to a probable required number of industrial trucks to be used. The information from logistics companies can also be taken into account with respect to the probable demand. The warehouse management system in this case is configured to receive data from a logistics company for goods to be stored and removed, and to provide it to the control system for determining the probable demand. In this way, it can for example be ensured that when a truck arrives with goods to be stored, sufficiently charged industrial trucks are available. It is likewise also known, for example, that when a truck to be loaded has a fixed departure time, the loading process must be concluded on time by the greater use of the industrial trucks. By taking into account this data for the logistics company, a seamless interplay of the flow of goods into the warehouse and out of the warehouse is possible. Preferably, the data received by the warehouse management system from the logistics company include one or more of the following pieces of information: the size, weight, etc. of goods to be stored or removed; information on an arrival, or respectively pick-up time of the goods; information on the quantity of goods; information on any delays in delivering, or respectively picking up the goods; information on a time window for delivering, or respectively picking up the goods; and information on special transport requirements for the goods. This information helps the energy management system and warehouse management in planning the demand and the anticipated use of the industrial trucks.

### BRIEF DESCRIPTION OF THE DRAWING

FIG. 1 illustrates a schematic diagram of an embodiment of system for energy management for battery-supplied industrial trucks.

### DETAILED DESCRIPTION OF THE INVENTION

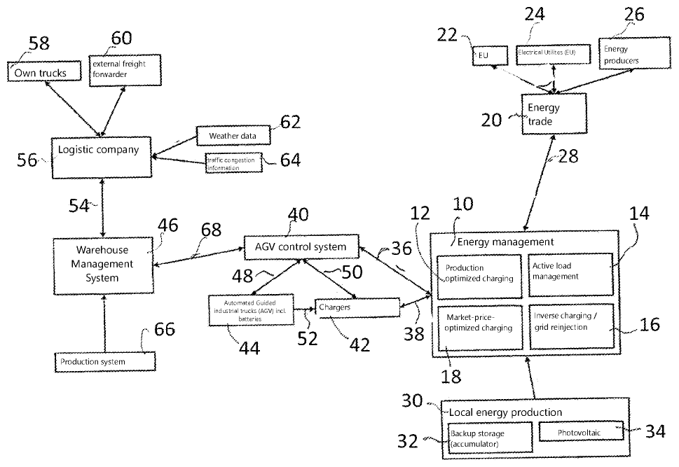

Referring to FIG. 1, the center is the energy management system 10 as an energy control unit that possesses four modules for the charging process. The module 12 relates to production-optimized charging, the module 14 relates to active load management, the module 18 relates to market-price-optimized charging, and the module 16 relates to inverse charging, or respectively reinjecting into the electrical supply network.

The module for production-optimized charging 12 works using the following information: the charging state of the batteries in the AGVs 44 and their remaining operating time; the probable demand for AGVs calculated by a warehouse management system 46; and the charging state of batteries 44 connected to the chargers 42 and their remaining operating time. The module 12 provides a charging strategy for the individual industrial trucks from these quantities and establishes at which time which batteries of the industrial truck should be charged.

The module 14 for active load management attempts to stabilize, if possible, the power drawn over the course of day from the electrical supply network. This is to prevent an excessive load from being drawn from the electrical supply network, for example at a shift change or another time. The module 14 ensures that the power drawn is as even as possible.

The market-price-oriented module 18 takes into account information originating from the energy trade 20 when establishing the charging time. The energy trade 20 accesses information from the electrical utilities 22, the grid operators 24, and other energy producers 26. By using this information, the module 20 determines the current prices for providing electrical power and, if necessary, also for injecting electrical power. This information is exchanged via an interface 28 with the energy management system 10 and can be taken into account by the module 18 for market-price-optimized charging. The module 18 for market-price-optimized charging can consequently make it recommendable to fully charge the available batteries as much as possible and also charge any local backup storage because of a low power purchasing price. This charging process is independent of the actual logistical demand. Likewise, the module for market-price-optimized charging 18 can, in the instance that the power purchase price assumes a high value, drain local backup storage, use any photovoltaic systems, and otherwise restrict the charging of the batteries to the absolutely necessary minimum. Likewise, the module for market-price-optimized charging 18 can in this case switch, for example, to accessing other energy supply sources. The module 16 for inverse charging, or respectively reinjecting into the network, also uses the data from the interface and creates estimations of whether electrical energy stored in the system can be fed back into the electrical supply network in order to thereby achieve additional profit.

The energy management system is connected to local energy producers, or respectively storage systems 30. These can be backup storage systems (accumulators) of the like, for example, that can be set up in the proximity of the chargers, or also centrally in the warehouse. The backup storage systems can store electrical energy and release it again if necessary, wherein these store the electrical energy from the electrical supply network or from a local energy producer 30 and release the energy thereto or to the industrial trucks. A photovoltaic system 34 is for example a support for the energy management system and makes it possible to provide additional electrical power.

The four modules 12, 14, 16, 18 of the energy management system are coordinated with each other. Mainly production-optimized charging 12 is carried out to ensure the availability of the industrial trucks in the warehouse and therefore the production flow. Second in priority is market-price-optimized charging 18 as well as grid reinjection 16 followed by active load management 14, which avoids current peaks and therefore jumps in cost in power purchasing. If active load management 14 intervenes because current peaks need to be avoided within the in-house infrastructure of the power network, this is higher priority than market-price-optimized charging and inverse charging. This results from the technical necessity for the energy management system to avoid current and voltage peaks. The energy management system is particularly effective when the industrial trucks work with lithium-ion batteries since they can also allow partial charging and intermediate charging and can therefore be used flexibly.

The energy management system 10 communicates with an AGV control system 40 and the chargers 42 via the interfaces 36 and 38. Another part of the AGV control system 40 is direct logical data exchange with the chargers 42 and the AGV batteries 44 with each of their associated batteries. The AGV control system 40 controls the AGVs that work autonomously in the warehouse. It takes over route planning for the individual AGVs and implements the transport orders from the warehouse management system 46 by having the individual AGVs transport the goods. Alternatively, it can also be provided that the AGV control system only transmits and monitors the transport orders and charging orders by indicating the start and target locations to the AGVs; however, route planning is performed autonomously by each AGV. In the context of this invention, the provision of information for the energy management system 10 and the implementation of charging recommendations for the AGVs are central.

The chargers 42 are controlled by the energy management system 10 via the interface 38. The interface 36 takes over general communication between the energy management system 10 and the AGV control system 40. The charging states of the AVGs 44 are queried via the interface 48 along with the remaining operating time of the battery. This information is forwarded to the energy management system 10 via the interface 36. The interface 50 serves for the AGV control system 40 to exchange information with the chargers. Accordingly, the chargers 42 report to the AGV control system 40 which AGVs 44 are available and their remaining charging time. The AGV control system can switch chargers via the interface 50, and the energy management system can also directly switch them via the interface 38. The information necessary for the charging process can be transmitted from the battery via the interface 52 to the charger.

The warehouse management system (WMS) 46 procures information via an interface 54 from one or more logistics companies 56. The exchange via the interface 54 can be bidirectional so that the warehouse management system 46 provides the logistics company 56 with information on loading and unloading processes in the warehouse, just as the logistics company 56 can direct information on the delivery or pick-up of goods to the warehouse management system 46. The logistics company 56 determines the probable arrival time of deliveries, wherein to accomplish this, it accesses information on their own trucks 58 and outside trucks from external freight forwarders 60. The logistics company 56 can also access generally available data such as for example weather data 62 and traffic congestion information 64 in order to take into account delays in the delivery.

The warehouse management system 46 is moreover connected to the production system 66 and receives information therefrom on the demand for goods for production, or respectively information on produced goods if they are intermediate products to be stored.

The sites of the goods located in the warehouse are also saved in the warehouse management system 46 along with the free storage locations. Free storage locations for delivered goods are assigned by means of the warehouse management system. This means that the AGV control system 40 is notified of the site for storage for a particular product by means of the interface 68. The AGV control system selects a suitable AGV for the transport order, and then passes on this location as a destination to the AGV transporting the product and also determines, if applicable, the mute to be traveled. In the same way, when a product is to be removed, the storage location to be approached, such as a shelf, and the target location of the product are transmitted by the warehouse management system 46 via the interface 68 to the AGV control system 40. The AGV control system then assigns a transport order by means of the interface 48 to an AGV that is particularly suitable for the transport order because it is currently or will soon be free and, for example, is located in the vicinity or has a correspondingly charged battery for the transport order. If applicable, the AGV control system 40 also creates the route to be traveled for the AGV and transmits it by means of the interface 48.

In principle, the warehouse management system 46 can also transmit desired delivery times and desired pick-up times for certain deliveries via the interface 54 to the logistics companies 56. In this manner, a smooth process can be guaranteed in the storage and removal of goods, and moreover the charging of the batteries for the AGVs is cost-optimized. In this case, the information from the warehouse management system 46 is provided via the interface 68.

The charging processes for the AGV fleet are planned by the energy management system 10. To this end, the energy management system 10 receives information on the current charging state of the AGVs 44 as well as the future energy demand of the AGV fleet from the AGV control system 40 via the interface 36, and/or from the chargers 42 via the interface 38. This energy demand is based on the transport orders from the warehouse management system 46. On this basis, the energy management system 10 plans the charging processes for the AGVs 44 by means of the module 12 in order to ensure the operation of the warehouse. Moreover, additional requirements such as market prices, voltage peaks, and the stabilization of energy extraction from the grid are taken into account by means of modules 14-18. From the charging strategy optimized in this way, specific charging orders, i.e., charging times and charging durations, or respectively desired battery charging states for each AGV 44, are determined by the energy management system 10 and transmitted to the AGV control system 40 by means of the interface 36. Depending on if an AGV 44 is to be charged or if energy is to be removed therefrom for injection into the network, such an order must be transmitted to the corresponding charger 42. This can be done directly via the interface 38 from the energy management system 10, from the AGV control system by means of the interface 50, or through the AGV 44 by means of the interface 52. The AGV control system plans the charging orders received from the energy management system 10 by transmitting to the AGVs 44 the chargers 42 to be approached as well as the charging durations and, if applicable, the routes to be traveled for this purpose. If applicable, the charging duration can also be transmitted directly by means of the interface 50 to the chargers 42.

### LIST OF REFERENCE SIGNS

10 Energy management system
12 Module for production-optimized charging
14 Module for active load management
16 Module for inverse charging, respectively reinjecting into the electrical supply network
18 Module for market-price-optimized charging
20 Energy trade module
22 Electrical supply network
24 Network operator
26 Other energy producers
28 Interface
30 Local energy production
32 Storage system
34 Photovoltaic system
36 Interface
38 Interface
40 AGV control system
42 Chargers
44 AGVs
46 Warehouse management system
48 Interface
50 Interface
52 Interface
54 Interface
56 Logistics company
58 Own trucks
60 Outside trucks from external freight forwarders
62 Weather data
64 Traffic congestion information
68 Interface

1. A system for energy management of a plurality of battery-powered industrial trucks comprising:
an energy control unit configured to,
receive data on a current charging state of the plurality of battery-powered industrial trucks,
receive data on a probable demand for the plurality of battery-powered industrial trucks, and
receive data on use of chargers used to charge the plurality of battery-powered industrial trucks,
wherein the energy control unit is configured use the using the received data to determine when each of the plurality of battery-powered industrial trucks is being charged at an available charger, and when each of the plurality of battery-powered industrial trucks is being used for the probable demand.

2. The system according to claim 1, wherein the plurality of battery-powered industrial trucks include at least one automated guided vehicle (AGV) configured to receive a driving order and automatically implement the driving order.

3. The system according to claim 1, further comprising a control system for the plurality of battery-powered industrial trucks configured to generate driving orders for each of the plurality of battery-powered industrial trucks and to send the driving orders to each of the plurality of battery-powered industrial trucks.

4. The system according to claim 3, wherein the control system is configured to receive a charging command for at least one of the plurality of battery-powered industrial trucks from the control unit and to forward the charging command to the at least one of the plurality of battery-powered industrial trucks.

5. The system according to claim 1, wherein the energy control unit is configured to receive parameters for a current state of a power network and to control at least one of: (1) a charging process; and (2) a discharging process for at least one battery to support the power network.

6. The system according to claim 4, wherein the control unit is configured to choose between at least two electrical supply networks for supplying the chargers, and wherein the control unit is configured to choose between the at least two electrical supply networks according to a current purchase price for electrical power.

7. The system according to claim 1, wherein the energy control unit is configured to inject electrical power into an electrical supply network from a battery connected to one of the chargers.

8. The system according to claim 7, wherein the energy control unit is configured to inject electrical power into the supply network depending on a current purchase price for electrical power.

9. The system according to claim 3, wherein the control system is configured to receive data from a warehouse management system and wherein the control system is configured to evaluate the received data when determining the probable demand for the plurality of battery-powered industrial trucks.

10. The system according to claim 9, wherein the warehouse management system is configured to receive data from a logistics company for goods to be stored and removed, and wherein the warehouse management system is configured to forward the received data to the control system to determine the probable demand.

11. The system according to claim 10, wherein the data from the logistics company received by the warehouse management system contain at least one of: information on goods to be stored or removed; information on an arrival, or respectively pick-up time of goods; information on a quantity of goods; information on any delays in delivering goods; information on any delays in picking up goods; information on a time window for delivering goods; information on a time window for picking up goods; and information on special transport requirements for goods.

12. The system according to claim 10, wherein the warehouse management system sends messages to the logistics company that contain one or more of the following pieces of information: information on goods to be stored or removed; information on an arrival, or respectively pick-up time of goods; information on a quantity of goods; information on a time window for delivering goods; information on a time window for picking up goods; and information on special transport requirements for goods.

13. A method for energy management of a plurality of battery-powered industrial trucks comprising:
determining a current charging state of the plurality of battery-powered industrial trucks;
determining a probable demand for the plurality of battery-powered industrial trucks;
determining a status of a plurality of battery chargers; and
using the determined current charging state of the plurality of battery-powered industrial trucks, the probable demand, and the status of the plurality of battery chargers to determine when at least one of the plurality of battery-powered industrial truck is being charged at one of the plurality of battery chargers, and to determine when the at least one of a plurality of battery-powered industrial trucks is being used for the probable demand.
